(19) United States
(12) Patent Application Publication
(10) Pub. No.: US 2022/0358932 A1
(43) Pub. Date: Nov. 10, 2022

(54) INFORMATION PROCESSING APPARATUS, INFORMATION PROCESSING METHOD, AND PROGRAM

(71) Applicant: Sony Group Corporation, Tokyo (JP)

(72) Inventors: Chika MYOGA, Tokyo (JP); Yasuharu ASANO, Tokyo (JP); Yoshinori MAEDA, Tokyo (JP)

(73) Assignee: Sony Group Corporation, Tokyo (JP)

(21) Appl. No.: 17/623,248

(22) PCT Filed: May 19, 2020
(86) PCT No.: PCT/JP2020/019762

§ 371 Date: Dec. 28, 2021

(30) Foreign Application Priority Data
Jul. 12, 2019 (JP) 2019-129764

(51) Int. Cl. G10L 15/32; G10L 15/22; G10L 15/01; G10L 21/0208

(52) U.S. Cl. CPC G10L 15/32; G10L 15/22; G10L 15/01; G10L 21/0208; G10L 2021/02082

(57) ABSTRACT

Disclosed is an information processing apparatus including a control section that estimates utterance environment information in a state where the control section is set to cooperate with a predetermined mobile terminal.

### TECHNICAL FIELD

The present disclosure relates to an information processing apparatus, an information processing method, and a program.

### BACKGROUND ART

Becoming popular is a device that automatically analyzes speech input from a user and returns an appropriate response to the user according to a result of analysis or performs work based on an instruction from the user. The device having such functions is referred to, for example, as a speech agent or a smart speaker. Further, an interface based on speech input through the speech agent is referred to as a voice UI (User Interface). To enable the voice UI to properly function, it is necessary that the speech agent accurately perform accurate speech recognition. PTL 1 below describes an apparatus that suppresses ambient noise around the apparatus in order to enable accurate speech recognition.

### CITATION LIST

### Patent Literature

[PTL 1]
Japanese Patent Laid-open No. 2016-42132

### SUMMARY

### Technical Problem

In the above-mentioned field, it is desired that an environment where the user utters a voice be properly estimated in order to build an environment where proper speech recognition is achieved.

An object of the present disclosure is to provide an information processing apparatus, an information processing method, and a program that are able to properly estimate an environment where a user utters a voice.

### Solution to Problem

According to an aspect of the present disclosure, there is provided an information processing apparatus including a control section that estimates utterance environment information in a state where the control section is set to cooperate with a predetermined mobile terminal.

According to another aspect of the present disclosure, there is provided an information processing method that includes causing a control section to estimate utterance environment information in a state where the control section is set to cooperate with a predetermined mobile terminal.

According to yet another aspect of the present disclosure, there is provided a program causing a computer to execute an information processing method that includes causing a control section to estimate utterance environment information in a state where the control section is set to cooperate with a predetermined mobile terminal.

According to still another aspect of the present disclosure, there is provided an information processing system including a mobile terminal and an information processing apparatus that is capable of cooperating with the mobile terminal. The information processing apparatus includes a control section that estimates utterance environment information in a state where the information processing apparatus is set to cooperate with a predetermined mobile terminal and that generates feedback information on the basis of a result of estimation of the utterance environment information. At least either the mobile terminal or the information processing apparatus includes a reporting section that reports the feedback information.

### BRIEF DESCRIPTION OF DRAWINGS

FIG. 1 is a schematic diagram illustrating a configuration example of an information processing system according to a first embodiment of the present disclosure.

FIG. 2 is a block diagram illustrating a configuration example of a mobile terminal according to the first embodiment.

FIG. 3 is a block diagram illustrating a configuration example of a smart speaker according to the first embodiment.

FIG. 4 is a flowchart that is referenced to describe an example of the operation of the information processing system according to the first embodiment.

FIG. 5 is a block diagram illustrating a configuration example of a smart speaker according to a second embodiment of the present disclosure.

FIG. 6 is a flowchart that is referenced to describe an example of the operation of the information processing system according to the second embodiment.

FIG. 7 is a diagram illustrating an example of visualized information.

FIG. 8 is a diagram illustrating another example of the visualized information.

FIG. 9 is a diagram illustrating yet another example of the visualized information.

FIG. 10 is a diagram illustrating still another example of the visualized information.

FIG. 11 is a diagram illustrating an additional example of the visualized information.

### DESCRIPTION OF EMBODIMENTS

Embodiments and modifications of the present disclosure will now be described with reference to the accompanying drawings. It should be noted that the description will be given in the following order.

### First Embodiment

### Second Embodiment

### Modifications

The embodiments and modifications described below are preferred concrete examples of the present disclosure. The present disclosure is not limited to the embodiments and modifications described below.

### First Embodiment

### Problems to be Considered

First of all, problems to be considered regarding the embodiments will be described to facilitate the understanding of the embodiments.

In the voice UI mentioned earlier, processing is generally performed in the following sequences.

Sequence 1: In a speech agent, the utterance of a user is converted to utterance text by speech recognition.

Sequence 2: The utterance text is converted into a form in which the user's utterance is machine interpretable, and information is extracted as needed for service execution by the speech agent.

Sequence 3: The extracted information is used to connect to an appropriate service.

Further, a speech input method can be classified into a near voice UI and a far voice UI. The near voice UI is applied when a microphone mounted on a device such as a smartphone or a smartwatch is positioned near the mouth of the user. The far voice UI is applied when the microphone mounted on the speech agent is positioned far from the mouth of the user as in the case of the voice UI using the speech agent.

In comparison with a device including the near voice UI, the speech agent including the far voice UI is easily affected by ambient noise and indoor reverberations, so that a speech recognition error is likely to occur due to such noise and reverberations. Further, in a case where an operation performed by the speech agent during the use of the voice UI is not intended by the user, it is conceivable that such an unintended operation is performed, for example, due to a speech recognition error caused during processing performed in the above-mentioned sequence 1, due to an inability to interpret the utterance text during processing performed in sequence 2, or due to insufficiency of information for connecting to a service during processing in sequence 3. However, it is difficult, for example, for a user who is unfamiliar with the voice UI to determine why an error has occurred in the operation performed by the speech agent.

Particularly, when an error occurs in speech recognition during the processing in sequence 1, it is difficult to recover from the error, so that the error may propagate to the processing in the later sequences. The speech recognition error can be fed back to the user by exercising a method of presenting the user with text indicating a speech recognition result. However, the speech recognition result cannot easily be presented by a device that is unable to generate a screen output. Further, the speech recognition error may be caused by various factors as mentioned above. Therefore, in a case where an environment where the error occurs remains unimproved, a similar error is highly likely to occur.

In view of the above circumstances, the first embodiment estimates the environment of a predetermined space (e.g., an outdoor or indoor space) where the user utters a voice, and then presents the user with information for building an environment where the speech recognition error is unlikely to occur. On the basis of the above, a detailed embodiment description will be given below.

### Configuration Example of Information Processing System

### Configuration Example of Whole System

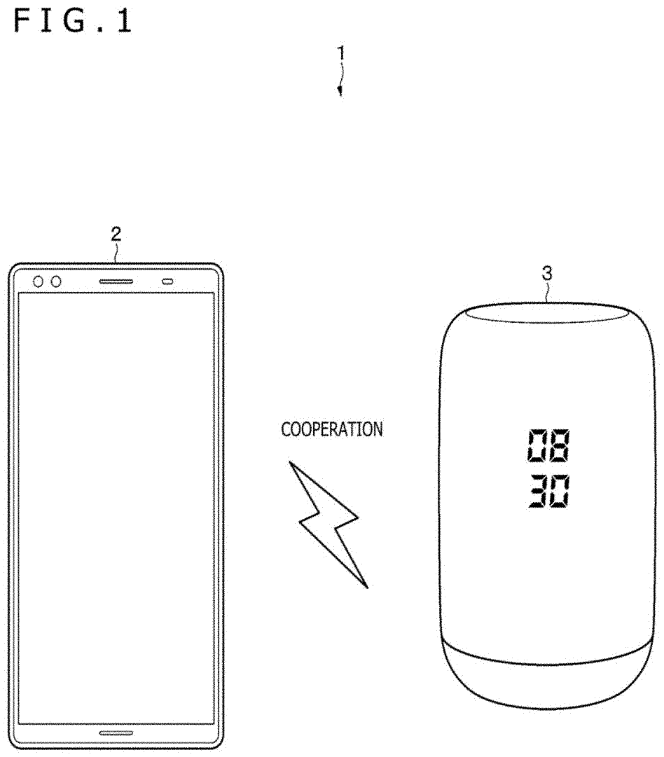

FIG. 1 is a schematic diagram illustrating a configuration example of an information processing system according to the present embodiment (information processing system 1). The information processing system 1 includes, for example, a mobile terminal 2 and a smart speaker 3. The smart speaker 3 is an example of an information processing apparatus. Although FIG. 1 depicts one mobile terminal 2 and one smart speaker 3, the information processing system 1 may include a plurality of mobile terminals 2 and one or more smart speakers 3. The mobile terminal 2 may be, for example, a smartphone or a wearable device that is attachable to a human body. The present embodiment assumes that the smart speaker 3 is a stationary device. However, the smart speaker 3 may alternatively be a portable size device or a wheeled type device.

The mobile terminal 2 and the smart speaker 3 cooperate with each other as far as they are set in a predetermined manner. Devices cooperating with each other are devices capable of transmitting and receiving various types of data between them through a predetermined network. The present embodiment assumes that the devices cooperate with each other by establishing wireless communication. However, the devices may cooperate with each other by establishing wired communication. The wireless communication to be established may be, for example, LAN (Local Area Network), Bluetooth (registered trademark), Wi-Fi (registered trademark), or WUSB (Wireless USB) communication.

### Configuration Example of Mobile Terminal

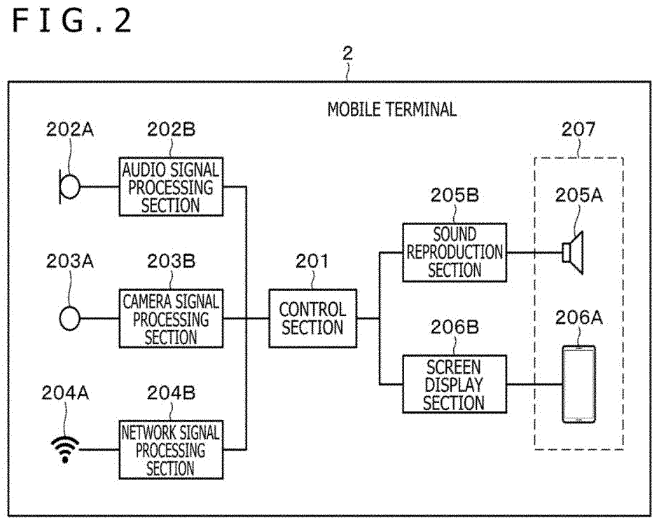

FIG. 2 is a block diagram illustrating a configuration example of the mobile terminal 2 according to the present embodiment. The mobile terminal 2 includes a control section 201, a microphone 202A, an audio signal processing section 202B, a camera unit 203A, a camera signal processing section 203B, a network unit 204A, a network signal processing section 204B, a speaker 205A, a sound reproduction section 205B, a display 206A, and a screen display section 206B. The audio signal processing section 202B is connected to the microphone 202A. The camera signal processing section 203B is connected to the camera unit 203A. The network signal processing section 204B is connected to the network unit 204A. The sound reproduction section 205B is connected to the speaker 205A. The screen display section 206B is connected to the display 206A. The audio signal processing section 202B, the camera signal processing section 203B, the network signal processing section 204B, the sound reproduction section 205B, and the screen display section 206B are each connected to the control section 201.

The control section 201 includes, for example, a CPU (Central Processing Unit). The control section 201 has, for example, a ROM (Read Only Memory) and a RAM (Random Access Memory) (these memories are not depicted). The ROM stores a program. The RAM is used as a work area for program execution. The control section 201 provides overall control of the mobile terminal 2. More specifically, the control section 201 exercises control to aggregate and synchronize signals inputted from the various units connected to the control section 201, and exercises control to aggregate and properly report information fed back from the smart speaker 3 (later-described feedback information).

The microphone 202A collects, for example, a user's utterance. The audio signal processing section 202B performs known audio signal processing on audio data of a sound collected through the microphone 202A.

The camera unit 203A includes, for example, an optical system component such as a lens and an image sensor. The camera signal processing section 203B performs image signal processing such as an A/D (Analog to Digital) conversion process, various correction processes, and an object detection process on images (still images and moving images are both acceptable) acquired through the camera unit 203A.

The network unit 204A includes, for example, an antenna. The network signal processing section 204B performs, for example, a modulation/demodulation process and an error correction process on data transmitted or received through the network unit 204A.

The sound reproduction section 205B performs a process of reproducing a sound through the speaker 205A. The sound reproduction section 205B performs, for example, an amplification process and a D/A conversion process. Further, when reproducing a sound through the speaker 205A, the sound reproduction section 205B specifically performs a process of generating a TSP (Time Stretched Pulse) signal and a reference sound.

The display 206A may be an LCD (Liquid Crystal Display) or an organic EL (Electro Luminescence) display. The screen display section 206B performs a known process for displaying various types of information on the display 206A. Alternatively, the display 206A may be configured as a touch screen. In such a case, the screen display section 206B additionally performs, for example, a process of detecting a position to which a touch operation is applied. It should be noted that, in the present embodiment, the speaker 205A and the display 206A are included in a reporting section 207 of the mobile terminal 2.

### Configuration Example of Smart Speaker

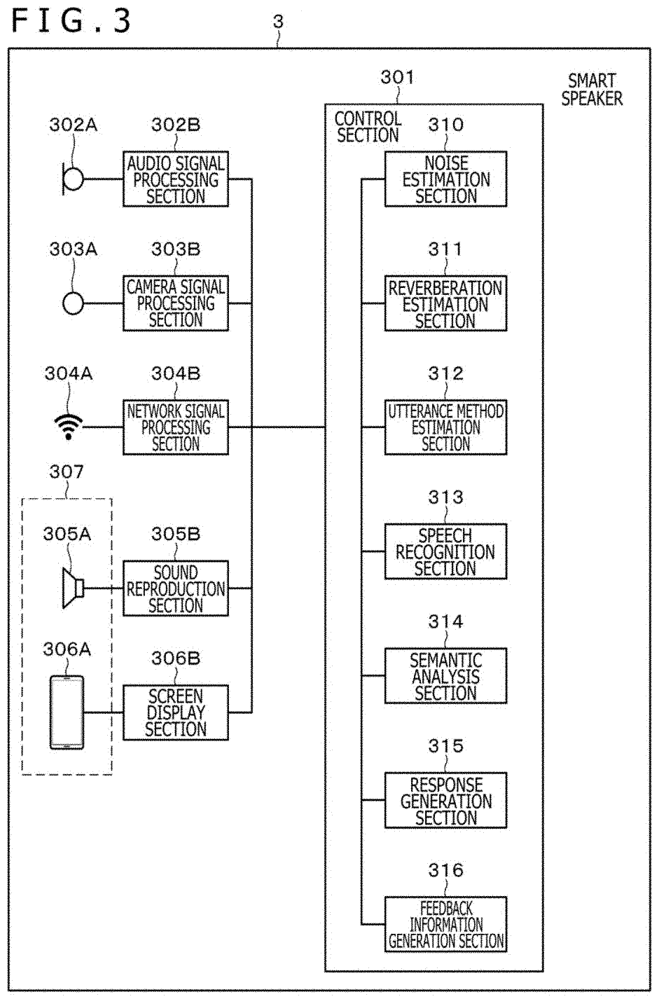

FIG. 3 is a block diagram illustrating a configuration example of the smart speaker 3 according to the present embodiment. The smart speaker 3 includes a control section 301, a microphone 302A, an audio signal processing section 302B, a camera unit 303A, a camera signal processing section 303B, a network unit 304A, a network signal processing section 304B, a speaker 305A, a sound reproduction section 305B, a display 306A, and a screen display section 306B. The audio signal processing section 302B is connected to the microphone 302A. The camera signal processing section 303B is connected to the camera unit 303A. The network signal processing section 304B is connected to the network unit 304A. The sound reproduction section 305B is connected to the speaker 305A. The screen display section 306B is connected to the display 306A. The audio signal processing section 302B, the camera signal processing section 303B, the network signal processing section 304B, the sound reproduction section 305B, and the screen display section 306B are each connected to the control section 301.

The control section 301 includes a noise estimation section 310, a reverberation estimation section 311, an utterance method estimation section 312, a speech recognition section 313, a semantic analysis section 314, a response generation section 315, and a feedback information generation section 316. These functional blocks are connected to each other, so that they are able to exchange data with each other.

The control section 301 includes, for example, a CPU. The control section 301 has, for example, a ROM and a RAM (these memories are not depicted). The ROM stores a program. The RAM is used as a work area for program execution. The control section 301 provides overall control of the smart speaker 3. It should be noted that the functional blocks included in the control section 301 will be described later.

The microphone 302A collects, for example, a user's utterance. The audio signal processing section 302B performs known audio signal processing on audio data of a sound collected through the microphone 302A.

The camera unit 303A includes, for example, an optical system component such as a lens and an image sensor. The camera signal processing section 303B performs image signal processing such as an A/D conversion process, various correction processes, and an object detection process on images (still images and moving images are both acceptable) acquired through the camera unit 303A.

The network unit 304A includes, for example, an antenna. The network signal processing section 304B performs, for example, a modulation/demodulation process and an error correction process on data transmitted or received through the network unit 304A.

The sound reproduction section 305B performs a process of reproducing a sound through the speaker 305A. The sound reproduction section 305B performs, for example, an amplification process and a D/A conversion process.

The display 306A may be an LCD or an organic EL display. The screen display section 306B performs a known process for displaying various types of information on the display 306A. Alternatively, the screen display section 306B may perform a process for displaying a projection on a wall or a screen without using the display 306A. It should be noted that the display 306A may alternatively be configured as a touch screen. In such a case, the screen display section 306B additionally performs, for example, a process of detecting a position to which a touch operation is applied. It should also be noted that, in the present embodiment, the speaker 305A and the display 306A (that may include a projection display) are included in a reporting section 307 of the smart speaker 3.

The control section 301 will now be described in detail. The control section 301 estimates utterance environment information in a state where the control section 301 is set to cooperate with the mobile terminal 2. Here, the utterance environment information is, specifically, information regarding a factor for reducing the accuracy of speech recognition. More specifically, the utterance environment information includes information regarding noise in a predetermined space or, in the present embodiment, noise in a space where the mobile terminal 2 and the smart speaker 3 are present. The information regarding noise includes information regarding at least one of the magnitude of noise, the direction of incoming noise, and the type of noise. Further, in the present embodiment, the utterance environment information includes information regarding a reverberation in a predetermined space.

The noise estimation section 310 estimates the information regarding noise on the basis of an audio signal that is collected by the microphone 302A and that is appropriately processed by the audio signal processing section 302B (this audio signal is hereinafter referred to, as needed, as an input audio signal).

The reverberation estimation section 311 uses the input audio signal to estimate the reverberation in an environment where the mobile terminal 2 and the smart speaker 3 are present. For example, the TSP signal is outputted from the mobile terminal 2 and is then collected by the microphone 302A. Subsequently, the audio signal processing section 302B performs, for example, an A/D conversion process on the TSP signal, and then, the resulting A/D-converted TSP signal is inputted to the control section 301. The mobile terminal 2 reproduces the TSP signal multiple times. The reverberation estimation section 311 adds up and averages the reproduced TSP signals, convolves a reversed TSP signal with the resulting sound to obtain an impulse response, and measures reverberation time by integrating the obtained impulse response. The measured impulse response includes information regarding, for example, frequency response, reflected sound, and direct sound in addition to reverberation characteristics. These pieces of information may be used as needed.

The utterance method estimation section 312 causes, for example, the speech recognition section 313 to recognize the reference sound reproduced by the mobile terminal 2, and compares text indicative of the result of speech recognition with reference text of an uttered voice. On the basis of the result of comparison, the utterance method estimation section 312 acquires the accuracy of speech recognition.

The speech recognition section 313 converts the input audio signal into text data by using a known method.

The semantic analysis section 314 analyzes the text data supplied from the speech recognition section 313, to determine the intention of the user, and extracts, from the text data, information necessary for achieving the intention of the user. The semantic analysis section 314 then supplies the result of extraction to the response generation section 315. When, for example, the text data says “Tell me about the weather in Tokyo tomorrow,” the semantic analysis section 314 determines that the user intends to inquire about the weather, and extracts necessary information, namely, date and time information “tomorrow” and location information “Tokyo.” Subsequently, the semantic analysis section 314 supplies the result of extraction to the response generation section 315.

The response generation section 315 accesses an undepicted database or web service through the network unit 304A and acquires required information according to the user's intention and the necessary information, which are supplied from the semantic analysis section 314. The response generation section 315 then generates a response that meets the user's intention. In such a case as described in the above example, the response generation section 315 exercises control to access a web service that provides weather forecast information. Then, on the basis of such control, the response generation section 315 acquires information regarding the weather in Tokyo tomorrow and generates response text data saying “The weather will be fine in Tokyo tomorrow.” The response generation section 315 converts the generated response text data into audio data by performing a speech synthesis process, and exercises control to reproduce a sound corresponding to the audio data through the speaker 305A.

The feedback information generation section 316 generates, on the basis of the results of estimation made by the noise estimation section 310 and the reverberation estimation section 311, feedback information to be fed back to the user. The feedback information is information that prompts the user to build an environment for increasing the accuracy of speech recognition.

For example, in a case where noise of a predetermined level or higher is estimated by the noise estimation section 310, the feedback information generation section 316 generates feedback information saying, for example, “Turn down the volume of a television set or a radio (which is a noise source)” in order to reduce the noise itself or its influence. Further, for example, in a case where a reverberation of a predetermined level or higher is estimated by the reverberation estimation section 311, the feedback information generation section 316 generates feedback information saying, for example, “Shut the curtains” or “Bring the mobile terminal 2 closer to the smart speaker 3” in order to reduce the influence of the reverberation.

The feedback information generated by the feedback information generation section 316 is reported to the user in at least either an audible manner or a visible manner by using the reporting section 307. The feedback information may be reported by using the reporting section 207 of the mobile terminal 2. Further, the feedback information may be reported by using both the reporting section 207 and the reporting section 307. It should be noted that the use of the reporting section 207 enables the user to check the feedback information at hand.

### Example of Operation of Information Processing System

### (Normal Operation)

An example of the operation of the information processing system 1 will now be described. First of all, an example of the normal operation of the information processing system 1 will be outlined. The user gives an utterance (e.g., in order to ask a question) including a word for activating the smart speaker 3 (this word is hereinafter referred to as a wake word). The user's utterance is stored by the microphone 302A and processed by the audio signal processing section 302B to generate the input audio signal. The speech recognition section 313 performs a speech recognition process on the input audio signal to convert the input audio signal into text data. In a case where the result of the speech recognition process indicates that the wake word is included, the text data is supplied to the semantic analysis section 314. The semantic analysis section 314 analyzes the user's intention on the basis of the text data. The result of the analysis is supplied to the response generation section 315. The response generation section 315 generates response text data representing the user's intention and generates audio data corresponding to the response text data. The speaker 305A reproduces the audio data through the sound reproduction section 305B.

### (Operation for Generating Feedback Information)

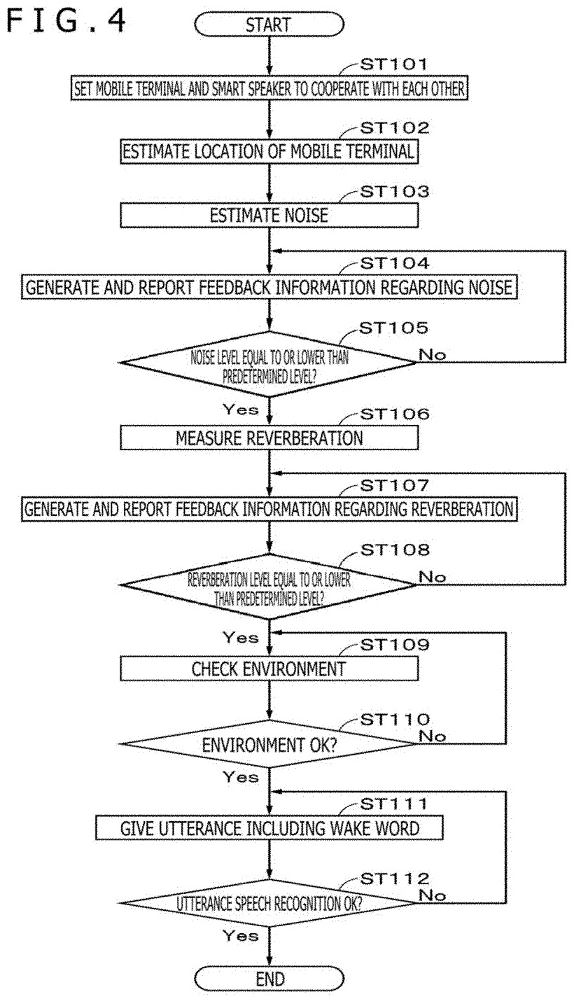

An example of the operation performed by the information processing system 1 to generate the feedback information will now be described with reference to the flowchart of FIG. 4. Processing described below is performed in a calibration manner when the smart speaker 3 is used.

When the processing starts, the mobile terminal 2 and the smart speaker 3 are set in step ST101 to cooperate with each other by using an appropriate method (setup method) such as the use of wireless LAN, Bluetooth (registered trademark), or wired LAN communication. Upon completion of step ST101, the processing proceeds to step ST102.

Step ST102 is performed to estimate a location of the mobile terminal 2. The user who is holding the mobile terminal 2 moves to a location where the user intends to speak to the smart speaker 3. The smart speaker 3 then estimates the location of the mobile terminal 2. In the present embodiment, for example, the camera unit 303A of the smart speaker 3 captures an image and allows the camera signal processing section 303B to perform an object detection process. On the basis of the result of the object detection process, the control section 301 estimates the location of the mobile terminal 2. In a case where the mobile terminal 2 includes a position sensor such as a GPS (Global Positioning System) sensor, the location of the mobile terminal 2 may be estimated on the basis of information acquired by such a position sensor. Further, the location of the mobile terminal 2 may be estimated by using information prescribed in a wireless communication standard. The location of the mobile terminal 2 may be estimated on the basis of an image captured by an infrared camera that is used as the camera unit 303A of the smart speaker 3. The location of the mobile terminal 2 may be estimated on the basis of a signal (beacon) outputted from the mobile terminal 2. In addition, the relative location of the mobile terminal 2 with respect to the smart speaker 3 may be inputted by the user of the mobile terminal 2. Upon completion of step ST102, the processing proceeds to step ST103.

In step ST103, the noise estimation section 310 estimates (measures) noise to generate information regarding the noise. When the location of the user and the mobile terminal 2 is determined, the smart speaker 3 records an ambient sound environment around the speaker. It should be noted that the user does not utter a voice during this processing. In a case where the smart speaker 3 includes a plurality of microphones 302A, the direction of a noise source can be estimated. The noise estimation section 310 analyzes the recorded sound to determine whether a sound like a human voice exists and whether noise other than a human voice exists. The noise estimation section 310 may prepare data indicating a link between a noise sound and noise information and determine the type of noise by a statistical learning method. Upon completion of step ST103, the processing proceeds to step ST104.

In step ST104, the feedback information generation section 316 generates feedback information on the basis of the information regarding the noise which is generated in step ST103. For example, the feedback information generation section 316 feeds back the probability of the speech recognition error occurring under the influence of the sound volume of a television set or a radio or the influence of the voice of a speaker other than the user, and generates information that prompts the user to reduce the noise by decreasing the sound volume of the television set or the radio, namely, generates feedback information that prompts the user to build an environment for increasing the accuracy of speech recognition. The feedback information may be information that indicates merely the magnitude of noise, namely, indicates whether or not the speech of the user is easily heard. The generated feedback information is reported through the reporting section 307. The generated feedback information may be transmitted to the mobile terminal 2 and be then reported through the reporting section 207. Upon completion of step ST104, the processing proceeds to step ST105.

In step ST104, the feedback information is reported. It is conceivable that the user will decrease the sound volume, for example, of the television set or the radio according to the reported feedback information. Decreasing the above sound volume reduces the noise. Therefore, in step ST105, the noise estimation section 310 estimates the level of the noise after the reporting of the feedback information. In a case where the noise estimation section 310 determines in step ST105 that the noise level is neither equal to nor lower than a predetermined level, the processing returns to step ST104, and the feedback information is generated again. Here, the feedback information includes, for example, information that prompts the user to further reduce the noise (e.g., “Turn down the volume of the television set further”). In a case where the noise estimation section 310 determines that the noise level is equal to or lower than the predetermined level, the processing proceeds to step ST106.

In step ST106, the reverberation estimation section 311 estimates (measures) a reverberation to generate information regarding the reverberation. The reverberation estimation is made by reproducing the TSP signal from the mobile terminal 2 as described above. Instead of the TSP signal, for example, an impulse signal, an M-system signal, or an ordinary sound may alternatively be used to estimate the reverberation. Upon completion of step ST106, the processing proceeds to step ST107.

In step ST107, the feedback information generation section 316 generates feedback information on the basis of the information regarding the reverberation which is generated in step ST106. For example, in a case where the level of the reverberation is equal to or higher than a predetermined level, the feedback information generation section 316 generates feedback information that prompts the user to reduce the influence of the reverberation by saying, for example, “Shut the curtains” or “Bring the mobile terminal 2 closer to the smart speaker 3,” namely, feedback information that prompts the user to build an environment for increasing the accuracy of speech recognition. The generated feedback information is then reported through the reporting section 307. Alternatively, the generated feedback information may be transmitted to the mobile terminal 2 and reported through the reporting section 207. Upon completion of step ST107, the processing proceeds to step ST108.

In step ST107, the feedback information is reported. It is conceivable that the user will shut the curtains or bring the mobile terminal 2 closer to the smart speaker 3 according to the reported feedback information. Such an action of the user reduces the reverberation. Therefore, in step ST108, the reverberation estimation section 311 estimates the level of the reverberation after the reporting of the feedback information. In a case where the reverberation estimation section 311 determines in step ST108 that the reverberation level is neither equal to nor lower than a predetermined level, the processing returns to step ST107, and the feedback information is generated again. Here, the feedback information includes, for example, information that prompts the user to further reduce the reverberation (e.g., “Bring the mobile terminal 2 much closer to the smart speaker 3”). In a case where the reverberation estimation section 311 determines that the reverberation level is equal to or lower than the predetermined level, the processing proceeds to step ST109. It should be noted that indoor reverberation characteristics obtained in a case where the reverberation is confirmed to be sufficiently reduced are applicable to sound correction in a subsequent process. Therefore, such reverberation characteristics may be stored.

In step ST109, a process is performed to check whether or not speech recognition can properly be performed in the environment built in steps ST101 to ST108. For example, the reference sound is reproduced from the mobile terminal 2 and is then collected by the microphone 302A. The audio signal processing section 302B performs an appropriate process on reference audio data outputted from the microphone 302A. The reference audio data processed by the audio signal processing section 302B is supplied to the utterance method estimation section 312. It should be noted that the mobile terminal 2 and the smart speaker 3 cooperate with each other. Therefore, the wake word need not be inputted in the process performed here. An alternative is to reproduce the reference sound at different sound volume levels and check which of different patterns achieves correct speech recognition. Another alternative is to perform computation by multiplying recorded reference audio data by the inverse of the reverberation characteristics measured in step ST106. Upon completion of step ST109, the processing proceeds to step ST110.

In step ST110, in a case where the reference audio data is correctly speech-recognized, the utterance method estimation section 312 determines that the environment is appropriate for speech recognition (the environment is OK). In a case where the utterance method estimation section 312 determines that the environment is appropriate for speech recognition, the processing proceeds to step ST111. It should be noted that, if a sound volume level suitable for speech recognition is found when a plurality of reference sounds is reproduced in step ST109, information regarding such a sound volume level may be fed back to the user. Further, the user may receive a report notifying that the environment appropriate for speech recognition has been built.

In a case where the reference sound is not correctly speech-recognized by the utterance method estimation section 312 in step ST110, the processing returns to step ST109. It should be noted that, in a case where the number of times the reference sound has incorrectly been speech-recognized exceeds a threshold (e.g., several times) in step ST110, a noise generation situation or the reverberation characteristics may have changed. In such a case, the processing may return to step ST103, and noise or the like may be re-estimated.

In step ST111, the user utters a voice including the wake word. The utterance of the user is collected by the microphone 302A of the smart speaker 3. The audio signal processing section 302B performs an appropriate process on audio data that corresponds to the utterance and that is outputted from the microphone 302A. The audio data processed by the audio signal processing section 302B is supplied to the speech recognition section 313 and speech-recognized by the speech recognition section 313. Upon completion of step ST111, the processing proceeds to step ST112.

Step ST112 is performed to determine whether or not speech recognition is correctly performed by the speech recognition section 313. In a case where speech recognition is correctly performed, for example, by identifying the wake word or receiving a predetermined instruction, the same processing operation as the above-described normal operation of the smart speaker 3 is performed, so that information corresponding to the utterance is presented to the user. Upon completion of step ST112, the processing terminates. In a case where a speech recognition error occurs in step ST112, information indicating that the speech recognition error is possibly caused not by an improper speech recognition environment but by an inappropriate manner of utterance of the user or an incorrect user utterance of the wake word is fed back to the user in order to prompt the user to say the wake word or an instruction again. Subsequently, the processing returns to step ST111, and speech recognition is performed again on a new utterance of the user.

### Advantages Provided by First Embodiment

According to the first embodiment described above, it is possible to estimate the utterance environment information regarding a space where speech recognition is performed in a state where the mobile terminal 2 cooperates with the smart speaker 3.

Further, it is possible to generate and report the feedback information based on the utterance environment information. Therefore, it is possible to assist the building of an environment where speech recognition is properly performed. Also, since an environment appropriate for speech recognition can be built, it is possible to minimize the occurrence of a speech recognition error in the smart speaker 3.

In addition, it is possible to create a situation where the speech recognition error is not caused by a speech recognition environment. Therefore, in a case where the speech recognition error is caused by an environment, it is possible to avoid a phenomenon in which the speech recognition error persistently occurs although the user gives a new utterance multiple times.

### Second Embodiment

A second embodiment of the present disclosure will now be described. It should be noted that components identical with or of the same nature as those described above are denoted by the same reference symbols in the description of the second embodiment and will not be redundantly described as needed. Further, unless otherwise stated, the matters described in conjunction with the first embodiment are applicable to the second embodiment. For example, the mobile terminal 2 according to the first embodiment may be used as a mobile terminal according to the second embodiment.

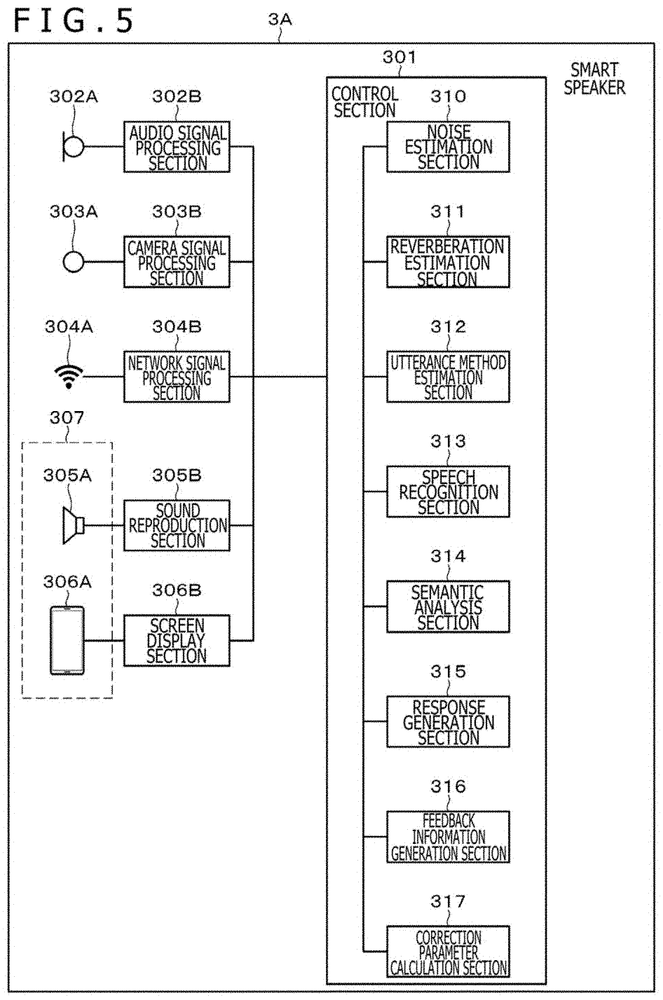

FIG. 5 is a block diagram illustrating a configuration example of a smart speaker (smart speaker 3A) according to the second embodiment. The configuration of the smart speaker 3A differs from the configuration of the smart speaker 3 in that the smart speaker 3A includes a correction parameter calculation section 317. The correction parameter calculation section 317 calculates a correction parameter on the basis of the audio data of the user's utterance that is collected by each of the mobile terminal 2 and the smart speaker 3A.

In the second embodiment, the user's utterance is collected by each of the mobile terminal 2 and the smart speaker 3A. As the collected audio data is used for processing, the mobile terminal 2 and the smart speaker 3A need to be time synchronized accurately before collection. One method of time synchronization is to periodically perform time synchronization (clock synchronization) with use of a PTP (Precision Time Protocol) between the mobile terminal 2 and the smart speaker 3A in a state where they cooperate with each other. Another method of time synchronization is to provide at least either the mobile terminal 2 or the smart speaker 3A with an LED (Light Emitting Diode) or other light-emitting element and achieve highly accurate time synchronization by interlocking the light emitting pattern of the LED on one of the mobile terminal 2 and the smart speaker 3A with image capturing by a camera mounted on the other one. Such a method may be implemented by using equipment disclosed, for example, in Japanese Patent Laid-open No. 2014-216549.

### Example of Operation of Information Processing System

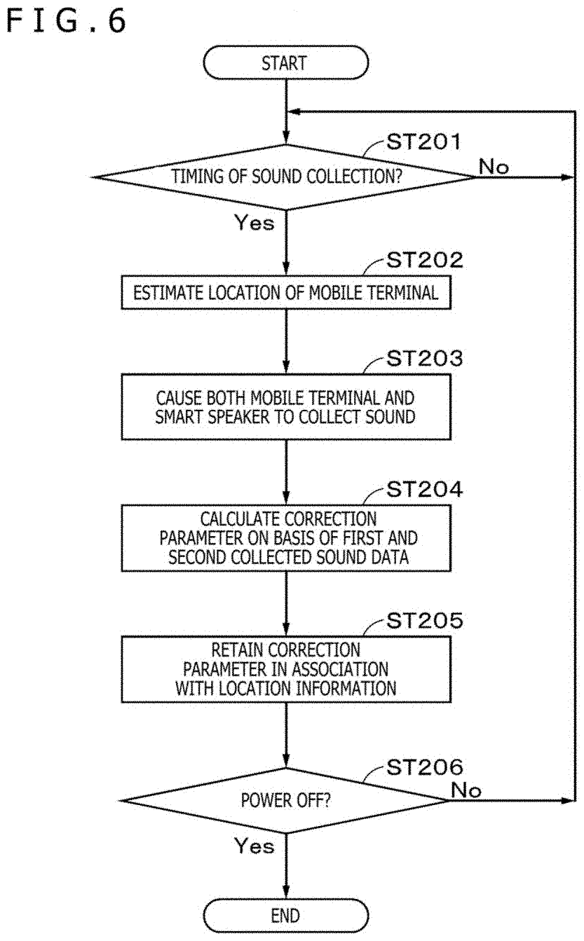

An example of the operation of the information processing system 1 according to the present embodiment will now be described with reference to the flowchart of FIG. 6. It should be noted that an example of the normal operation is the same as that described in conjunction with the first embodiment and will not be redundantly described.

When processing starts, step ST201 is performed to determine whether or not a timing of sound collection has come. Such a determination process is performed by each of the control sections (control section 201 and control section 301) of the mobile terminal 2 and the smart speaker 3A. The timing of sound collection is a timing when the user gives a trigger to the mobile terminal 2 and the smart speaker 3A by performing an explicit operation such as a button pressing operation. When, for example, the user is sitting on a sofa in a living room, is cooking in a kitchen, or has moved to a place where the user frequently uses the voice UI, the above trigger is given to the mobile terminal 2 and the smart speaker 3A. Further, the timing of sound collection may be a timing when the user brings the mobile terminal 2 having a proximity sensor provided therein close to the mouth of the user, for example, for speaking purposes. In such a case, the user need not perform an explicit operation. The mobile terminal 2 notifies the smart speaker 3A that the timing of sound collection has come. In a case where the timing of sound collection has not come, the processing returns to step ST201. In a case where the timing of sound collection has come, the processing proceeds to step ST202.

In step ST202, the smart speaker 3A estimates the location of the mobile terminal 2. For example, the camera unit 303A of the smart speaker 3A captures an image, and then, the camera signal processing section 303B performs image processing on the captured image to detect a person. The location of the detected person or its vicinity is estimated as the location of the mobile terminal 2. Alternatively, the mobile terminal 2 may capture an image with the camera unit 203A and estimate the location of the mobile terminal 2 from the captured image by using a SLAM (Simultaneous Localization and Mapping) technology. Further, the mobile terminal 2 may notify the smart speaker 3A of the estimated location of the mobile terminal 2. In a case where the smart speaker 3A does not include the camera unit 303A, the latter method is used. Upon completion of step ST202, the processing proceeds to step ST203.

In step ST203, the smart speaker 3A calculates the correction parameter on the basis of first collected sound data and second collected sound data. Audio data is generated when the user's utterance is collected by the microphone 202A of the mobile terminal 2. The first collected sound data is generated when the audio signal processing section 202B performs predetermined audio signal processing on the audio data. The first collected sound data is signal-processed in a predetermined manner by the network signal processing section 204B and transmitted to the smart speaker 3A through the network unit 204A. The first collected sound data is received by the smart speaker 3A. Further, audio data is generated when the above-mentioned user's utterance is collected by the microphone 302A of the smart speaker 3A. The second collected sound data is generated when the audio signal processing section 302B performs predetermined audio signal processing on the audio data.

The first collected sound data and the second collected sound data are supplied to the correction parameter calculation section 317 of the control section 301. The correction parameter calculation section 317 calculates the correction parameter on the basis of the first and second collected sound data. In the present embodiment, the mobile terminal 2 is positioned close to the user. Therefore, it is conceivable that sound is collected in an environment where the mobile terminal 2 is less affected, for example, by noise than the smart speaker 3A, which is positioned far from the user. Consequently, the correction parameter calculation section 317 calculates the correction parameter in such a manner that the second collected sound data approximates to the first collected sound data.

In general, noise can be classified into additive noise and multiplicative noise. The additive noise is the noise that is irrelevant to the user's utterance, such as the noise of an air conditioner. The multiplicative noise is, for example, the noise generated under the influence of a reverberation and represented by spatial transfer characteristics. The additive noise and the multiplicative noise correspond to the utterance environment information in the present embodiment. It should be noted that the multiplicative noise based on the characteristics of the microphone 202A of the mobile terminal 2 and the characteristics of the microphone 302A of the smart speaker 3A can be corrected in advance.

When the mobile terminal 2 collects a sound at a position close to the mouth of the user, it can be assumed that the audio data collected by the mobile terminal 2 is approximate to the user's utterance. Therefore, when time is represented by t and frequency is represented by ω, the following equation holds in a case where the observed spectrum of the second collected sound data is Os(ω,t), the observed spectrum of the first collected sound data is Op(ω,t), the multiplicative noise is H(ω), and the additive noise is A(ω,t).

Os(ω,t)=Op(ω,t)*H(ω)+A(ω,t)

The additive noise including noise and the multiplicative noise including a reverberation can be estimated by applying, for example, an adaptive filtering method to the first collected sound data and the second collected sound data. Subsequently, the correction parameter calculation section 317 calculates the correction parameter for suppressing the noise. Further, even when the above equation is not assumed, the correction parameter calculation section 317 is able to calculate the correction parameter (a network parameter in a neural network) by using a deep neural network (e.g., an autoencoder). Upon completion of correction parameter calculation, the processing proceeds to step ST205.

In step ST205, the correction parameter calculated in step ST204 is retained (stored) in association with the location of the mobile terminal 2, which is estimated in step ST202. Upon completion of step ST205, the processing proceeds to step ST206.

In step ST206, it is determined whether or not the smart speaker 3A is turned off. In a case where the smart speaker 3A is turned off, the processing terminates. However, as long as the smart speaker 3A is left turned on without being turned off, the processing returns to step ST201. It should be noted that, although not depicted, the correction parameter calculated in step ST204 is supplied to the audio signal processing section 202B and used to perform a correction process. This makes it possible to avoid a speech recognition error.

According to the present embodiment, it is possible to remove noise on a real time basis. Therefore, even in a case where the influence of noise or a reverberation is changed (e.g., the noise of an air conditioner is increased by turning up the air conditioning), the correction parameter is calculated. Consequently, the noise can properly be removed on the basis of the correction parameter.

### Examples of Presentation of Information Obtained by Visualizing Information Based on Utterance Environment Information

It should be noted that the correction parameter is used only temporarily if there is no means of estimating the information regarding the location of the user in step ST202. However, in the present embodiment, the location of the mobile terminal 2 is estimated, and location information indicative of the estimated location of the mobile terminal 2 is retained in association with the correction parameter calculated at the estimated location. By using the correction parameter associated with the location information in the above manner, it is possible to present the user with information obtained by visualizing the information based on the utterance environment information (the information obtained in this manner is hereinafter referred to as visualized information). For example, it is possible to present the user with information that is an example of utterance environment information, such as information indicative of the magnitude of influence exerted by noise or a reverberation at each location or information obtained by mapping the accuracy of speech recognition based on the former information. The magnitude of influence exerted by noise or a reverberation can be determined on the basis of the correction parameter. For example, it can be said that the magnitude of influence exerted by noise or a reverberation may increase with an increase in the amount of suppression of additive noise and multiplicative noise by the correction parameter, and the accuracy of speech recognition may thus be decreased. In the present embodiment, the correction parameter is retained for each location. Therefore, it is possible to determine the accuracy of speech recognition at each location and thus generate information obtained by mapping the accuracy of speech recognition at each location. The visualized information can be displayed by using the reporting section 207, the reporting section 307, or other appropriate equipment.

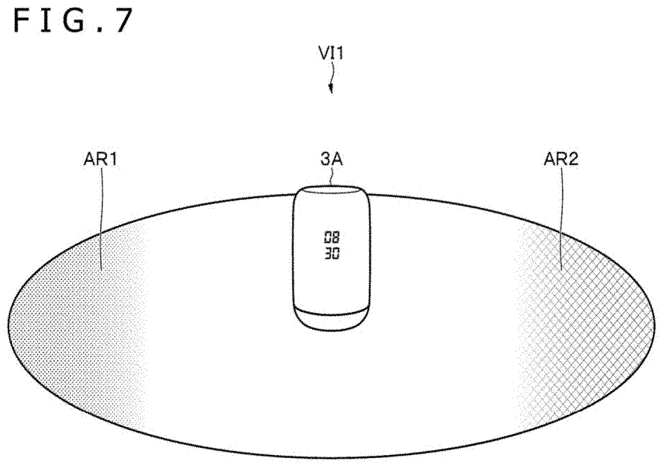

FIG. 7 is a diagram illustrating an example of the visualized information. Visualized information VI1 depicted in FIG. 7 is information displayed by a heat map to indicate the noise level around the smart speaker 3A. For example, an area AR1 which is one of the areas around the smart speaker 3A has a high noise level and is displayed in red. Meanwhile, an area AR2 which is one of the areas around the smart speaker 3A has a low noise level and is displayed in blue. Upon viewing the visualized information VI1, the user is able to recognize that speech input in the area AR2 reduces the speech recognition error. It should be noted that the colors displayed according to the noise level are not limited to red and blue and can be changed as appropriate.

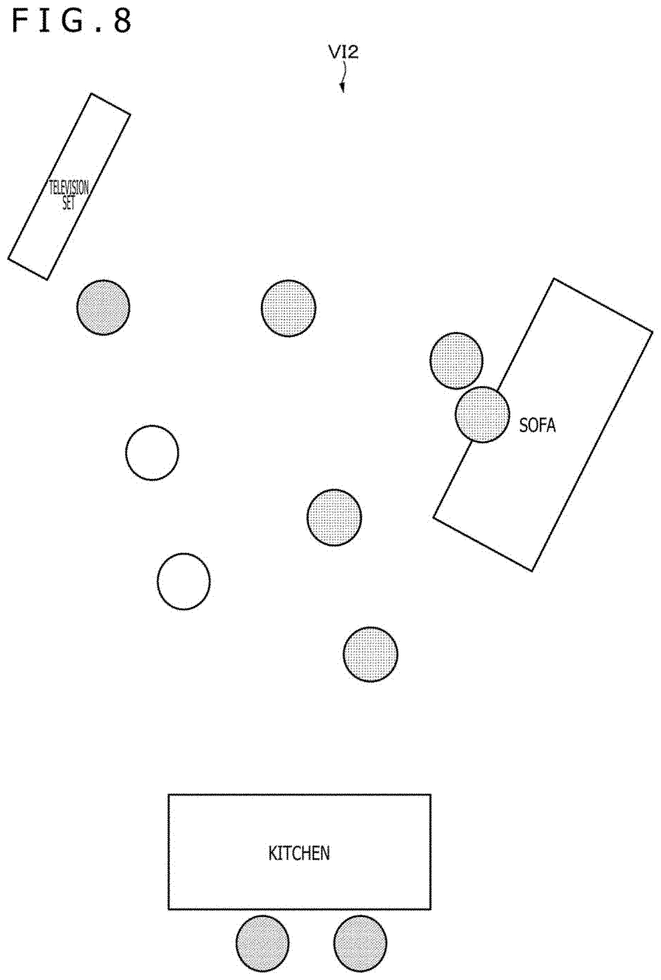

The visualized information is also useful when the user of the smart speaker 3A determines an installation location of the smart speaker 3A. For example, when the above-described processing is performed while the installation location of the smart speaker 3A in a living room is being changed, the levels of the noise and the reverberation at each location are determined after each change. The levels of the noise and the reverberation at each location are displayed by using, for example, visualized information VI2 depicted in FIG. 8. The visualized information VI2 displays items (a television set, a sofa, and a kitchen) in the living room according to their locations. Further, the visualized information VI2 displays, for example, circular marks to indicate a plurality of installation locations of the smart speaker 3A. The circular marks are internally colored in different colors depending, for instance, on the levels of the noise and the reverberation. The example of FIG. 8 indicates that the levels of the noise and the reverberation increase with an increase in the internal color density of the circular marks and that the circular marks having such an increased internal color density represent locations unsuitable for installation of the smart speaker 3A. The user viewing the above-described visualized information VI2 is able to visually recognize the installation locations of the smart speaker 3A that provide comfortable use of the voice UI.

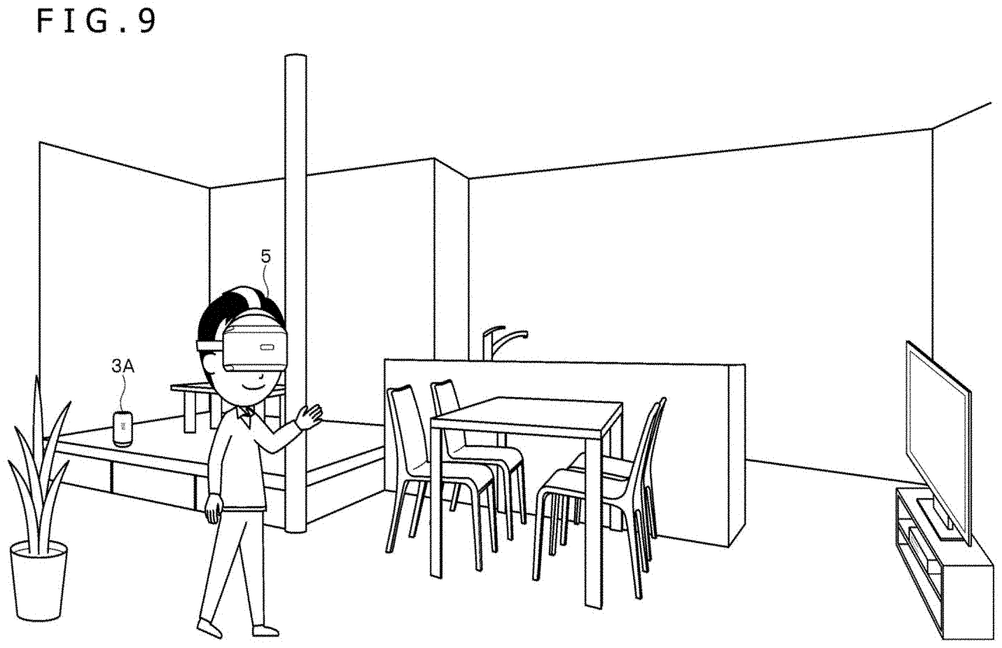

The visualized information may be presented to the user through the use of AR (Augmented Reality) or VR (Virtual Reality). For example, as depicted in FIG. 9, when the user wearing a HUD (Head Up Display) 5 enters the living room where the smart speaker 3A is installed at a predetermined location, the visualized information is presented to the user through the HUD 5.

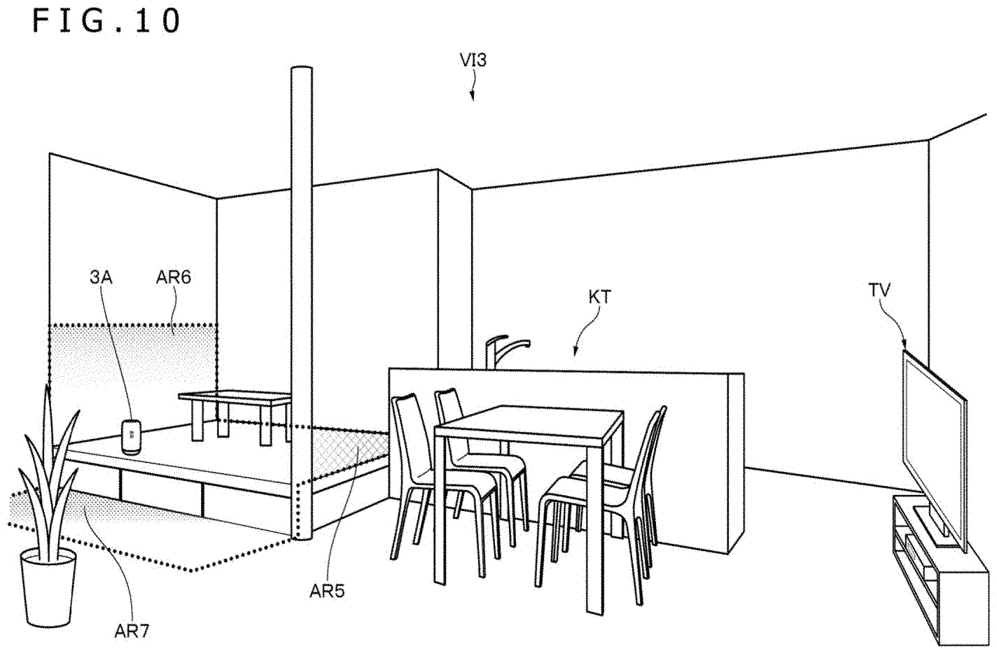

FIG. 10 is a diagram illustrating an example of visualized information (visualized information VI3) that is presented through the HUD 5. For example, an area AR5 is easily affected by the sounds of a kitchen KT and a television set TV and is thus displayed, for example, in red to indicate that a speech recognition error is likely to occur. Meanwhile, an area AR6 and an area AR7 are not easily affected by the sounds of the kitchen KT and the television set TV and are thus displayed, for example, in blue to indicate that the speech recognition error is unlikely to occur.

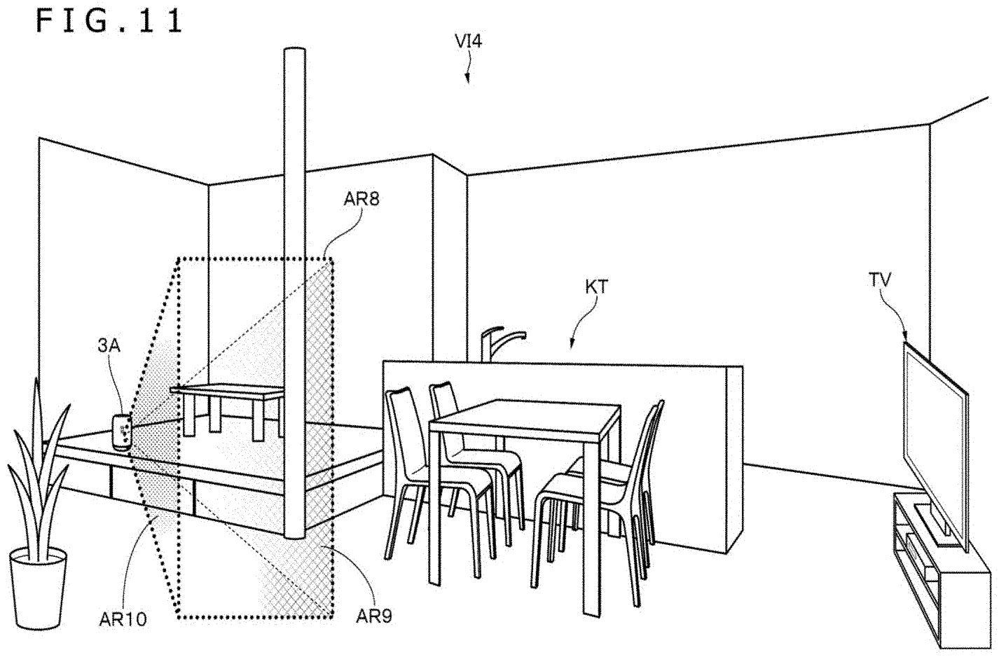

FIG. 11 is a diagram illustrating an example of visualized information (visualized information VI4) that is presented through the HUD 5. The example of FIG. 11 depicts an area AR8 where the smart speaker 3A is able to perform speech recognition. The area AR8 has a size that is preset, for example, for the smart speaker 3A. Within the area AR8, an area where the speech recognition error is unlikely to occur and an area where the speech recognition error is likely to occur may be colored in different colors. For example, an area AR9 within the area AR8 is close to the kitchen KT and the television set TV and is easily affected by the sounds of the kitchen KT and the television set TV. The area AR9 is thus displayed, for example, in red to indicate that the speech recognition error is likely to occur. On the other hand, an area AR10 within the area AR8 is relatively far from the kitchen KT and the television set TV and is not easily affected by the sounds of the kitchen KT and the television set TV. The area AR10 is thus displayed, for example, in blue to indicate that the speech recognition error is unlikely to occur. It should be noted that only the area AR8 where the smart speaker 3A is able to perform speech recognition may be displayed.

Presenting the visualized information by using AR enables the user to concretely recognize an area where the speech recognition error is unlikely to occur, and recognize the relation between such an area and various items arranged in a real space.

### Modifications

The embodiments of the present disclosure have been described in detail above. However, the present disclosure is not limited to the foregoing embodiments. Various modifications can be made on the basis of the technical idea of the present disclosure.

The first and second embodiments may be combined. For example, the feedback information may be reported in the second embodiment. Further, the results of estimation, for example, of the noise level may be stored as a history in the first embodiment to present the visualized information described in conjunction with the second embodiment.

It should be noted that the above-described configurations of the mobile terminal 2 and the smart speakers 3 and 3A are merely examples. Therefore, the mobile terminal 2 and the smart speakers 3 and 3A may exclude some of the above-described components and have configurations different from the above-described ones. The mobile terminal 2 and the smart speakers 3 and 3A may include, for example, a jack and a physical operation input section such as a button. Further, the mobile terminal 2 may include a memory that is detachable from the mobile terminal 2. Further, the smart speakers 3 and 3A may include a large-capacity memory (database).

The smart speakers 3 and 3A according to the foregoing embodiments may cooperate with a plurality of mobile terminals 2.

Some of the steps in the above-described processing may be performed in a changed order or performed in a parallel manner.

The present disclosure may be implemented, for example, by an apparatus, a method, a program, or a system. When, for example, a downloadable program for performing the functions described in conjunction with the foregoing embodiments is prepared and is then downloaded and installed in an apparatus that does not have the functions described in conjunction with the foregoing embodiments, the apparatus is able to exercise the control described in conjunction with the foregoing embodiments. The present disclosure may be also implemented by a server that distributes such a program. Further, the matters described in conjunction with the foregoing embodiments and modifications may be combined as appropriate.

It should be noted that the present disclosure should not restrictively be interpreted from the advantages described in the present disclosure.

The present disclosure can also adopt the following configurations.

(1)

An information processing apparatus including:

a control section that estimates utterance environment information in a state where the control section is set to cooperate with a predetermined mobile terminal.

(2)

The information processing apparatus as described in (1), in which the utterance environment information is related to a factor for reducing accuracy of speech recognition.

(3)

The information processing apparatus as described in (2), in which the utterance environment information includes information regarding noise in a predetermined space.

(4)

The information processing apparatus as described in (3), in which the information regarding noise includes information regarding at least one of magnitude of noise, a direction of incoming noise, and a type of noise.

(5)

The information processing apparatus as described in any one of (2) to (4), in which the utterance environment information includes information regarding a reverberation in a predetermined space.

(6)

The information processing apparatus as described in (5), in which the information processing apparatus receives a reverberation measurement signal outputted from the mobile terminal, to acquire the information regarding a reverberation.

(7)

The information processing apparatus as described in any one of (2) to (6), in which the control section generates feedback information on the basis of a result of estimation of the utterance environment information.

(8)

The information processing apparatus as described in (7), in which the feedback information prompts building of an environment for increasing the accuracy of the speech recognition.

(9)

The information processing apparatus as described in (7) or (8), further including:

a reporting section that reports the feedback information.

(10)

The information processing apparatus as described in (9), in which the feedback information is reported in at least either an audible manner or a visible manner.

(11)

The information processing apparatus as described in any one of (2) to (10), further including:

a speech recognition section that performs the speech recognition.

(12)

The information processing apparatus as described in any one of (1) to (11), in which the control section acquires a correction parameter on the basis of first audio data and second audio data, the first audio data being inputted to the mobile terminal, the second audio data being time synchronized with the first audio data and collected by the information processing apparatus.

(13)

The information processing apparatus as described in (12), in which the correction parameter causes the second audio data to approximate to the first audio data.

(14)

The information processing apparatus as described in any one of (1) to (13), further including:

a location information acquisition section that acquires location information of the mobile terminal.

(15)

The information processing apparatus as described in (14), in which the control section generates visualized information by visualizing information based on a plurality of pieces of the location information and on the utterance environment information corresponding to each of the plurality of pieces of the location information.

(16)

The information processing apparatus as described in any one of (1) to (15), in which, when being connected to the mobile terminal through a network, the information processing apparatus is set to cooperate with the mobile terminal.

(17)

An information processing method including:

causing a control section to estimate utterance environment information in a state where the control section is set to cooperate with a predetermined mobile terminal.

(18)

A program causing a computer to execute an information processing method that includes causing a control section to estimate utterance environment information in a state where the control section is set to cooperate with a predetermined mobile terminal.

(19)

An information processing system including:

a mobile terminal; and

an information processing apparatus that is capable of cooperating with the mobile terminal, in which

the information processing apparatus includes a control section that estimates utterance environment information in a state where the information processing apparatus is set to cooperate with a predetermined mobile terminal and that generates feedback information on the basis of a result of estimation of the utterance environment information, and

at least either the mobile terminal or the information processing apparatus includes a reporting section that reports the feedback information.

### REFERENCE SIGNS LIST

1: Information processing system
2: Mobile terminal
3, 3A: Smart speaker
207, 307: Reporting section
301: Control section
303A: Camera unit
313: Speech recognition section
316: Feedback information generation section
317: Correction parameter calculation section

1. An information processing apparatus comprising:
a control section that estimates utterance environment information in a state where the control section is set to cooperate with a predetermined mobile terminal.

2. The information processing apparatus according to claim 1, wherein the utterance environment information is related to a factor for reducing accuracy of speech recognition.

3. The information processing apparatus according to claim 2, wherein the utterance environment information includes information regarding noise in a predetermined space.

4. The information processing apparatus according to claim 3, wherein the information regarding noise includes information regarding at least one of magnitude of noise, a direction of incoming noise, and a type of noise.

5. The information processing apparatus according to claim 2, wherein the utterance environment information includes information regarding a reverberation in a predetermined space.

6. The information processing apparatus according to claim 5, wherein the information processing apparatus receives a reverberation measurement signal outputted from the mobile terminal, to acquire the information regarding a reverberation.

7. The information processing apparatus according to claim 2, wherein the control section generates feedback information on a basis of a result of estimation of the utterance environment information.

8. The information processing apparatus according to claim 7, wherein the feedback information prompts building of an environment for increasing the accuracy of the speech recognition.

9. The information processing apparatus according to claim 7, further comprising:
a reporting section that reports the feedback information.

10. The information processing apparatus according to claim 9, wherein the feedback information is reported in at least either an audible manner or a visible manner.

11. The information processing apparatus according to claim 2, further comprising:
a speech recognition section that performs the speech recognition.

12. The information processing apparatus according to claim 1, wherein the control section acquires a correction parameter on a basis of first audio data and second audio data, the first audio data being inputted to the mobile terminal, the second audio data being time synchronized with the first audio data and collected by the information processing apparatus.

13. The information processing apparatus according to claim 12, wherein the correction parameter causes the second audio data to approximate to the first audio data.

14. The information processing apparatus according to claim 1, further comprising:
a location information acquisition section that acquires location information of the mobile terminal.

15. The information processing apparatus according to claim 14, wherein the control section generates visualized information by visualizing information based on a plurality of pieces of the location information and on the utterance environment information corresponding to each of the plurality of pieces of the location information.

16. The information processing apparatus according to claim 1, wherein, when being connected to the mobile terminal through a network, the information processing apparatus is set to cooperate with the mobile terminal.

17. An information processing method comprising:
causing a control section to estimate utterance environment information in a state where the control section is set to cooperate with a predetermined mobile terminal.

18. A program causing a computer to execute an information processing method that includes causing a control section to estimate utterance environment information in a state where the control section is set to cooperate with a predetermined mobile terminal.
